(19) United States
(12) Patent Application Publication
(10) Pub. No.: US 2015/0202839 A1
(43) Pub. Date: Jul. 23, 2015

(54) INTERIOR MEMBER AND METHOD OF MANUFACTURING THE SAME

(71) Applicant: TOYOTA JIDOSHA KABUSHIKI KAISHA, Toyota-shi (JP)

(72) Inventor: Yasuo KAWASHIMA, Nagoya-shi (JP)

(73) Assignee: TOYOTA JIDOSHA KABUSHIKI KAISHA, Toyota-shi (JP)

(21) Appl. No.: 14/595,707

(22) Filed: Jan. 13, 2015

(30) Foreign Application Priority Data
Jan. 21, 2014 (JP) 2014-008642

(51) Int. Cl. B32B 7/08; D06B 1/00; B32B 5/18; D05B 15/00

(52) U.S. Cl. CPC B32B 7/08; D05B 15/00; D06B 1/00; B32B 5/18; B32B 2250/02; B32B 2262/0223; B32B 2266/0278; B32B 2605/00

(57) ABSTRACT

A skin material and a urethane foam layer directly or indirectly overlap each other, a water-swellable sewing thread is sewn through the skin material and the urethane foam layer, and the water-swellable sewing thread is swollen. As a result, an interior member is formed.

### INCORPORATION BY REFERENCE

The disclosure of Japanese Patent Application No. 2014-008642 filed on Jan. 21, 2014 including the specification, drawings and abstract is incorporated herein by reference in its entirety.

### BACKGROUND OF THE INVENTION

1. Field of the Invention

The present invention relates to an interior member including a skin material and a urethane foam layer, and a method of manufacturing the same.

2. Description of Related Art

A foaming technique of integrating a urethane foam with a skin material (cover) in an interior member of a vehicle has been put into practice as a processing method capable of simplifying a covering work of a skin material and reducing the manufacturing cost.

In the existing integral foaming process of a skin material and a urethane foam, a seal is attached to the inside of sewn portions of the skin material to prevent urethane from entering into the sewn portions.

However, actually, it is extremely difficult to specify a sewn portion from which urethane or the like is leaked, or to control a urethane leakage position to be a desired position. Accordingly, even when a seal is attached to a partial region of a back surface of a skin material, a urethane leakage prevention effect is not high.

Therefore, for example, urethane leakage can be solved using a method of attaching a seal to the entire surface of a back surface of a skin material. However, this method has other problems in that the material cost of a seal is high, and time and effort are required to attach a seal to the entire surface. Thus, it is difficult to say that this method is effective.

In addition, with the method of attaching a seal to a partial region or the entire surface of a back surface of a skin material, it is extremely difficult to take a countermeasure against urethane leakage in a skin material in which sewn portions are complicatedly entangled.

Japanese Patent Application Publication No. 2005-290570 (JP 2005-290570 A) discloses a technique of sewing a skin by using a sewing thread as a yarn constituting a core to suppress the leakage of a foaming agent from a sewing hole of the skin, the sewing thread being coated with an adhesive in which expandable microcapsules are dispersed.

However, in this method, a process of coating a sewing thread with an adhesive in which expandable microcapsules are dispersed is necessary. Therefore, it is obvious that the processing time is long, and the material cost and the processing cost are high.

In addition, International Publication WO 2006/001067 discloses a technique of sewing a skin using a sewing thread containing a thermal adhesive fiber.

Even in the method disclosed in International. Publication WO 2006/001067, the processing cost of the sewing thread containing a hot-melt fiber is high. In addition, although the thermal adhesive fiber is melted by a heat treatment to fill sewing holes, heat generated during the melting may damage the sewing thread.

### SUMMARY OF THE INVENTION

The invention relates to an interior member of a vehicle obtained by integrating a urethane foam with a skin material, and a method of manufacturing the same, in which sewing holes formed when the interior member is sewn using a sewing thread can be sufficiently blocked, and an interior member having high urethane leakage prevention performance can be manufactured at a low material cost irrespective of a processing method.

According to a first aspect of the invention, there is provided an interior member including: a skin material; a urethane foam layer that directly or indirectly overlaps the skin material; and a water-swellable sewing thread that is sewn through the skin material and the urethane foam layer. The water-swellable sewing thread is swollen.

In the interior member according to the invention, the skin material and the urethane foam layer directly or indirectly overlap each other so as to be in close contact with each other and are sewn using the water-swellable sewing thread. In this case, the water-swellable sewing thread is swollen. By the sewing thread being swollen, sewing holes formed during the sewing are blocked, and a urethane foam which forms the urethane foam layer on a back surface of the skin material is prevented from being leaked to the skin material.

Since all the sewing holes are blocked by the water-swellable sewing thread being swollen, a process of specifying a urethane leakage portion which requires time and effort is also not necessary. Further, the blocking of sewing holes which is considered to be extremely difficult can be easily performed.

In addition, since only the water-swellable sewing thread is used, urethane leakage can be prevented at a low material cost. As a result, the production yield of the interior member is also extremely high.

Here, “the skin material and the urethane foam layer directly or indirectly overlapping each other” includes a configuration in which the skin material and the urethane foam layer directly overlap each other and a configuration in which another urethane layer is interposed between the skin material and the urethane foam layer. In particular, from the viewpoint of preventing leakage during the molding of the urethane foam layer, it is preferable that after a laminate of the skin material and a urethane layer is sewn, the urethane foam layer be formed on the urethane layer side. Therefore, a configuration in which the skin material, the urethane layer, and the urethane foam layer are laminated is preferable. Here, in the configuration including the urethane layer, the skin material and the urethane layer can be collectively referred to as “cover”, and in the configuration not including the urethane layer, only the skin material can be referred to as “cover”.

This interior member can be used not only as a seat for a vehicle but also as small-sized interior parts of a vehicle such as a headrest or a console.

The skin material is not particularly limited, and, for example, genuine leather or synthetic leather can be used. Further, examples of the water-swellable sewing thread include a cross-linked polymer of water-soluble vinyl monomers, and this material has sufficient strength for sewing.

In addition, according to a second aspect of the invention, there is provided a method of manufacturing an interior member. This method includes: sewing an intermediate member, in which a skin material and a urethane layer are in close contact with each other, with a water-swellable sewing thread put into a needle such that the water-swellable sewing thread is sewn through the skin material and the urethane layer; supplying water to at least a sewn portion to swell the sewing thread and to block sewing holes; and forming a urethane foam layer on the urethane layer side to manufacture an interior member.

Before the integral foaming of urethane, the intermediate member in which the skin material and the urethane layer are in close contact with each other is prepared first, and the intermediate member is sewn with the water-swellable sewing thread put into a needle such that the water-swellable sewing thread is sewn through the skin material and the urethane layer. Next, the sewing thread is swollen to block sewing holes.

Here, as the intermediate member, for example, a laminate of genuine leather which is the skin material and slab urethane which is the urethane layer can be used. By forming the urethane foam layer on the slab urethane side, the affinity between both the slab urethane and the urethane foam layer is excellent, and the adhesion is also improved.

Once the sewing holes are blocked, the intermediate member is put into a molding die, and heat is applied thereto to perform integral foam molding of urethane. As a result, an interior member is manufactured.

In the method according to the invention, during the formation of the urethane foam layer, sewing holes in the vicinity of the sewing thread with which the skin material and the urethane layer are sewn are blocked. As a result, since urethane leakage through the sewing holes is prevented, a high production yield can be realized.

In addition, after sewing the skin material and the urethane layer with the water-swellable sewing thread, the method includes the simple sewing hole blocking process of supplying water to a sewn portion to swell the sewing thread. Therefore, the production efficiency is high.

As can be understood from the above description, with the interior member and the method of manufacturing the same according to the invention, the skin material and the urethane foam layer are sewn with the water-swellable sewing thread, and this sewing thread is swollen. As a result, sewing holes formed during the sewing are blocked, and an interior member having high urethane leakage prevention performance can be manufactured.

### BRIEF DESCRIPTION OF THE DRAWINGS

Features, advantages, and technical and industrial significance of exemplary embodiments of the invention will be described below with reference to the accompanying, drawings, in which like numerals denote like elements, and wherein:

FIG. 1 is a diagram illustrating a flow of a method of manufacturing an interior member according to the invention;

FIG. 2 is a diagram illustrating a flow of the method of manufacturing an interior member following FIG. 1; and

FIG. 3 is a diagram illustrating a flow of the method of manufacturing an interior member following FIG. 2 and illustrating an interior member according to the invention.

### DETAILED DESCRIPTION OF EMBODIMENTS

Hereinafter, embodiments of an interior member and a method of manufacturing the same according to the invention will be described with reference to the drawings.

### Embodiments of Interior Member and Method of Manufacturing the Same

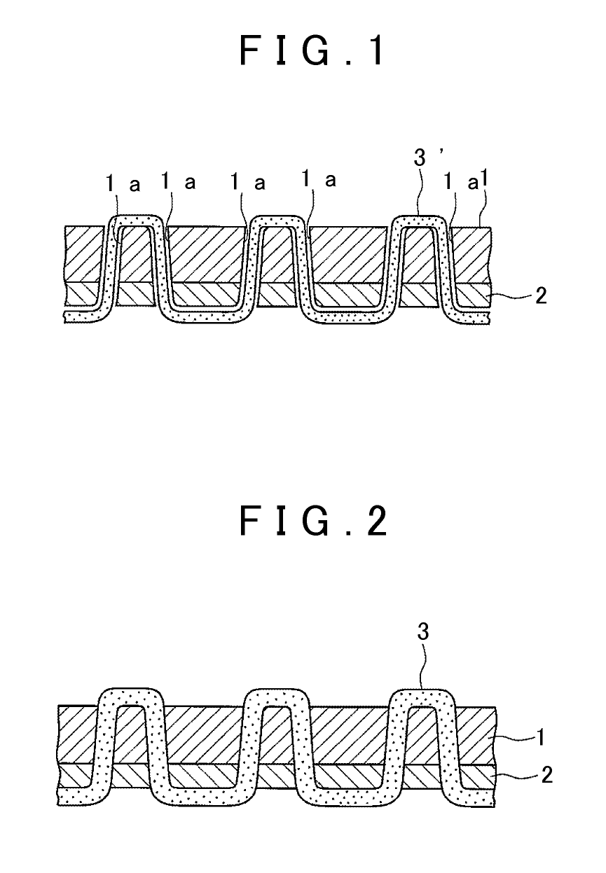

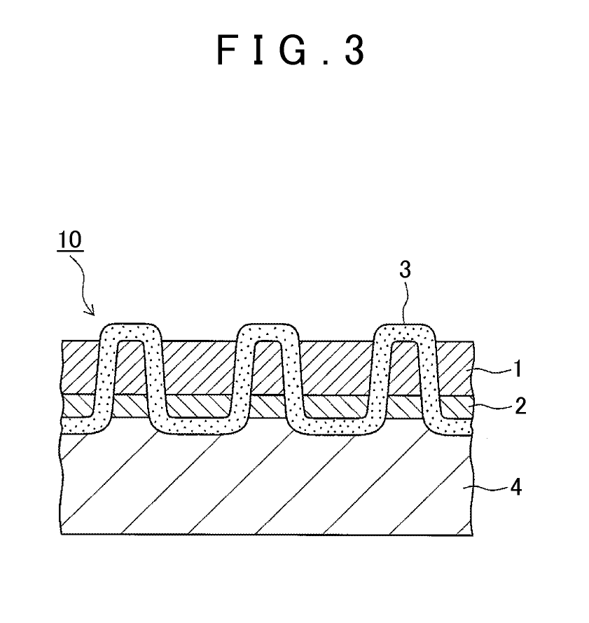

FIGS. 1, 2, and 3 are diagrams illustrating flows of a method of manufacturing an interior member according to the invention in order of FIGS. 1, 2, and 3. FIG. 3 also illustrates an interior member according to the invention.

First, as illustrated in FIG. 1, an intermediate member in which a skin material 1 and a urethane layer 2 are in close contact with each other is prepared, and this intermediate member is sewn with a water-swellable sewing thread 3′ put into a needle (not illustrated) such that the water-swellable sewing thread 3′ is sewn through the skin material 1 and the urethane layer 2.

Here, the skin material is not particularly limited, and, for example, genuine leather, synthetic leather, or fabric can be used.

In addition, examples of the water-swellable sewing thread include a cross-linked polymer of water-soluble vinyl monomers such as (meth)acrylamide, (meth)acrylic acid, 2-acrylamide-2-methylpropanesulfonic acid, vinylsulfonic acid, and styrenesulfonic acid; grafted starch; cyanoethylated starch; and carboxymethylated starch. During the sewing, sewing holes 1a are formed in the vicinity of the sewing thread 3′.

Next, water is supplied to, for example, the sewing thread 3′ facing the urethane layer 2 side to be swollen. As a result, a sewing thread 3 is formed. As illustrated in FIG. 2, the sewing holes 1a are completely blocked by the swollen sewing thread 3.

Once the sewing holes 1a are completely blocked by the swollen sewing thread 3, this intermediate member is put into a molding die, and heat is applied thereto to perform integral foam molding of urethane. Due to this foam molding, as illustrated in FIG. 3, an interior member 10 in which a urethane foam layer 4 is formed on the urethane layer 2 side is manufactured.

Since the urethane layer 2 and the urethane foam layer 4 are formed of the same resin, the affinity between the urethane layer 2 and the urethane foam layer 4 is excellent. In addition, by a part of the sewing thread 3 facing up to the urethane foam layer 4, the entirety of the skin material 1, the urethane layer 2, and the urethane foam layer 4 is sewn by the swollen sewing thread 3.

With the interior member 10 and the method of manufacturing the same according to the invention illustrated in the drawings, the skin material 1 and the urethane foam layer 4 are sewn with the water-swellable sewing thread 3, and this sewing thread 3 is swollen. As a result, sewing holes formed during the sewing are completely blocked, and the interior member 10 having high urethane leakage prevention performance can be manufactured.

### Experiment for Inspecting Whether or Not There is Urethane Leakage During Formation of Urethane Foam Layer, and Results Thereof

The present inventors have performed an experiment for inspecting whether or not there is urethane leakage during the formation of the urethane foam layer.

### Method of Manufacturing Sample and Inspection Method

A laminate of genuine leather (manufactured by Midori Hokuyo Co., Ltd.) or fabric and slab urethane was sewn. In Examples 1 to 3, a water-swellable sewing thread (AQUASEAL manufactured by Fil-Tec Inc.) was used for the sewing, and in Comparative Examples 1 and 2, seal attachment or no countermeasure was taken against urethane leakage.

In Examples 1 to 3, the sewing thread on the slab urethane side was wetted with a sponge containing water, and residual water was wiped with a dry cloth. In this case, it was confirmed that sewing holes were blocked with the sewing thread.

Next, each of the laminates of Examples 1 to 3 and Comparative Examples 1 and 2 was put into a molding die, and heat was applied thereto to perform integral foam molding of urethane. As a result, each of samples of Examples 1 to 3 and Comparative Examples 1 and 2 was prepared.

Each of the samples was visually inspected from the skin material side to inspect whether or not there was urethane leakage. The specification and experiment result of each of the samples are shown in Table 1 below.

TABLE 1

| | Corresponding | | |
|---|---|---|---|
| | Method in Integral | Cover | Experiment |
| | Foaming | Configuration | Result |
| Comparative | None | Fabric | Urethane Leakage |
| Example 1 | | Slab Urethane | Observed |
| Comparative | Seal Attachment to | Fabric | Urethane Leakage |
| Example 2 | Partial Region of | Slab Urethane | Observed |
| | Cover Back Surface | Seal | |
| Example 1 | Sewing with | Fabric | Urethane Leakage |
| | Water-Swellable | Slab Urethane | Not Observed |
| | Sewing Thread | | |
| Example 2 | Sewing with | Genuine Leather | Urethane Leakage |
| | Water-Swellable | Slab Urethane | Not Observed |
| | Sewing Thread | | |
| Example 3 | Sewing with | Synthetic Leather | Urethane Leakage |
| | Water-Swellable | Slab Urethane | Not Observed |
| | Sewing Thread | | |

From Table 1, the results of the experiment were as follows. In Comparative Examples 1 and 2 in which no countermeasure against urethane leakage was taken in the water-swellable sewing thread, urethane leakage was observed. On the other hand, in Examples 1 to 3 in which the countermeasure against urethane leakage was taken in the water-swellable sewing thread, urethane leakage was not observed, and the effects of the manufacturing method according to the invention were able to be confirmed.

Hereinabove, the embodiments of the invention have been described with reference to the drawings. However, a specific configuration is not limited to the embodiments, and design changes and the like which are made within a range not departing from the scope of the invention are included in the invention.

What is claimed is:

1. An interior member comprising:
a skin material;
a urethane foam layer that directly or indirectly overlaps the skin material; and
a water-swellable sewing thread that is sewn through the skin material and the urethane foam layer, wherein
the water-swellable sewing thread is swollen.

2. The interior member according to claim 1, wherein
the water-swellable sewing thread is formed of a cross-linked polymer of water-soluble vinyl monomers.

3. A method of manufacturing an interior member comprising:
sewing an intermediate member, in which a skin material and a urethane layer are in close contact with each other, with a water-swellable sewing thread put into a needle such that the water-swellable sewing thread is sewn through the skin material and the urethane layer;
supplying water to at least a sewn portion to swell the sewing thread and to block sewing holes; and
forming a urethane foam layer on an urethane layer side to manufacture the interior member.

4. The method according to claim 3, wherein
the water-swellable sewing thread is formed of a cross-linked polymer of water-soluble vinyl monomers.
